(19) United States
(12) Patent Application Publication
(10) Pub. No.: US 2026/0037411 A1
(43) Pub. Date: Feb. 5, 2026

(54) GENERATION OF USER INTERFACE TESTS FROM A VIDEO

(71) Applicant: Micro Focus LLC, Wilmington, DE (US)

(72) Inventors: Mazzy Atzmon, Yehud (IL); Dror Saaroni, Yehud (IL); Ayal Cohen, Yehud (IL)

(73) Assignee: Micro Focus LLC, Wilmington, DE (US)

(21) Appl. No.: 18/791,540

(22) Filed: Aug. 1, 2024

(51) Int. Cl. G06F 11/36

(52) U.S. Cl. CPC G06F 11/3684; G06F 11/3688; G06F 11/3696

(57) ABSTRACT

Software applications require testing to ensure they operate as intended. Testing of an application under test (AUT) can be automated by executing a test script, but developing test scripts requires a skilled engineer to modify the AUT and/or instrumentation to be applied to a test platform to record user actions used to develop a test script. By obtaining a video of a user interacting with an AUT on an uninstructed test platform, an artificial intelligence (AI) may determine the actions the user takes and the objects to which those actions are directed. Additionally, the user's intentions may be determined so that a test script may be developed or fine-tuned to be successful even if the AUT has visually changed since the video was obtained.

### FIELD OF THE DISCLOSURE

The invention relates generally to systems and methods for developing automated test scripts and particularly to utilizing an artificial intelligence to determine a testers intention for one or more actions taken with an application under test and developing automated test scripts therefrom.

### BACKGROUND

A major part of application development is developing and executing tests to verify that the application behaves correctly. In order to make these verifications, a developer or quality assurance (QA) engineer is required to create automation tests. These tests are scripts which will be executed multiple times to identify errors and make sure the application is working correctly. The script is comprised of multiple steps which contains application objects and actions. An example of a test script used to fill in a login dialog is:
Editfield (“User name”).setText “John Doe”
Editfield (“Password”).setText “VerySecretPassword”
Button (“login”).click

Traditionally, in order to create the tests, the user either creates a test design, wherein the user writes the script in order to identify the objects and uses inspection tools or code the properties manually, or the user activates a record capability, and then every interaction that the user is doing is recorded to the script.

Manual test design is slow and requires skilled technical capabilities in scripting and a deep understanding of the application. The recording method, which may seem perfect, is an online process which requires the testing tool to be installed on the machine of the user as it needs to hook into the application and execute background computations in order to understand the end user's intentions. The hooking process can impact the application and might not catch all user's actions.

### SUMMARY

Traditional application testing solutions use manual test authoring and recording capabilities to generate the tests comprising an automated test script. These methods require a highly skilled engineer to accurately write tests and/or instrumentation for the application. In addition, these methods often require test data, which may or may not accurately represent real user data. Instead, the test data may comprise quick inputs that allow the application to make decisions efficiently but with less data.

These and other needs are addressed by the various embodiments and configurations of the present disclosure. The present disclosure can provide a number of advantages depending on the particular configuration. These and other advantages will be apparent from the disclosure of the invention(s) contained herein.

In one embodiment, a test is developed from a video of the user using the application, and the output is a script which represents the actions the end user performed on the application. The video may be a live stream or a recording of a past user interaction.

Machine learning algorithms are utilized to detect and identify objects (e.g., graphical elements) displayed to the user on a screen presenting the application under test (AUT). For each frame of the video, the machine learning algorithm then learns and understands what the objects on the screen are by using an artificial intelligence (AI) object detection engine. The AI object detection engine receives a picture (e.g., frame(s) of the video image) and returns an identifier or description of the object(s) on the screen, similar to a human describing the contents of a screen presenting the AUT.

Differences between the frames are analyzed in order to identify the end user action(s) that caused the difference. For example, typing text in a text field can be identified by comparing the frames and the values in the text field. Once the object, the action, and the data are identified, a script line can be added to the generated test indicating the action, the object that is the target of the action, and a result in accordance with the difference in the frames of the video. The test may then utilize the AI determined objects, which were determined from the video and without requiring human input.

As a further benefit, the AUT may be used for test generation without applying any instrumentation or installation of any testing programs that may affect the operation or performance of the device executing the AUT. Only the video, live or recorded, such as from a video camera or video capturing component able to capture the contents of a screen presenting the graphical output of the AUT, is required.

In another embodiment, the use of AI object detection may produce erroneous object identifications. This is more common when using inspection tools or the recording method (see above) that captures a screenshot at a certain time for analysis of the objects captured. As there is only one screenshot, there can be erroneous object identifications. By utilizing certain embodiments herein, multiple frames may be analyzed to determine what objects are in each frame. The identification of the objects may then be performed on a plurality of frames. The AI object detection engine can skip frames or portions of frames that are identical or substantially similar.

In some aspects, the techniques described herein relate to a method, including: accessing a video including a plurality of video frames of a user using an application under test (AUT); using an artificial intelligence (AI) to determine a user intention associated with the AUT from at least one of the plurality of video frames; generating a test script including a set of operations that perform the user intention; and writing the test script to a data storage.

In some aspects, the techniques described herein relate to a method, wherein using the AI to determine the user intention associated with the AUT from at least one of the plurality of video frames further includes providing a prompt to the AI, the prompt including the at least one of the plurality of video frames, a domain associated with the AUT, a plurality of prior videos, each prior video including a prior user interacting with a prior application under test to accomplish a prior user intention, and a request to determine the user intention.

In some aspects, the techniques described herein relate to a method, wherein generating the test script including the set of operations that perform the user intention further includes generating the test script to include variations of at least one of a user action and an object of a graphical user interface (GUI) generated by the AUT receiving the user action.

In some aspects, the techniques described herein relate to a method, wherein using the AI to determine the user intention associated with the AUT from at least one of the plurality of video frames further includes detecting a user action performed on an object of a graphical user interface (GUI) generated by the AUT.

In some aspects, the techniques described herein relate to a method, wherein using the AI to determine the user intention associated with the AUT from at least one of the plurality of video frames further includes providing a first frame of the plurality of video frames showing a user action on an object and a second frame of the plurality of video frames, and wherein the second frame of the plurality of video frames shows a result of the user action.

In some aspects, the techniques described herein relate to a method, wherein the AI includes a neural network trained to receive the video and determine therefrom the user intention.

In some aspects, the techniques described herein relate to a method, wherein the neural network is trained to determine the user intention, including: collecting a set of prior videos, each prior video including video frames of a set of prior users using a prior application under test; applying one or more transformations to each of the prior videos, including selecting a different object to perform a prior user action, altering the prior user action, and obtaining a different prior result to create a modified set of prior videos; creating a first training set including the collected set of prior videos, the modified set of prior videos, and a set of videos absent the user intention; training the neural network in a first stage of training using the first training set; creating a second training set for a second stage of training including the first training set and members of the set of videos absent the user intention incorrectly detected as having the user intention after the first stage of training; and training the neural network in the second stage of training using the second training set.

In some aspects, the techniques described herein relate to a method, wherein training the neural network further includes training the neural network on the set of prior videos including videos of the set of prior users using the prior application under test within a common domain as the AUT.

In some aspects, the techniques described herein relate to a method, further including executing, test script to test the AUT.

In some aspects, the techniques described herein relate to a system, including: at least one microprocessor coupled with a computer memory including instructions that, when read by the at least one microprocessor, cause the microprocessor to: access a video including a plurality of video frames of a user using an application under test (AUT); execute an artificial intelligence (AI) to determine a user intention associated with the AUT from at least one of the plurality of video frames; generate a test script including a set of operations that perform the user intention; and write the test script to a data storage.

In some aspects, the techniques described herein relate to a system, wherein executing the AI to determine the user intention associated with the AUT from at least one of the plurality of video frames further includes instructions to provide a prompt to the AI, the prompt including the at least one of the plurality of video frames, a domain associated with the AUT, a plurality of prior videos, each prior video including a prior user interacting with a prior application under test to accomplish a prior user intention, and a request to determine the user intention.

In some aspects, the techniques described herein relate to a system, wherein the instructions to generate the test script including the set of operations that perform the user intention further include instructions to generate the test script to include variations of at least one of a user action and an object of a graphical user interface (GUI) generated by the AUT receiving the user action.

In some aspects, the techniques described herein relate to a system, wherein executing the AI to determine the user intention associated with the AUT from at least one of the plurality of video frames further includes instructions to detect a user action performed on an object of a graphical user interface (GUI) generated by the AUT.

In some aspects, the techniques described herein relate to a system, wherein executing the AI to determine the user intention associated with the AUT from at least one of the plurality of video frames further includes instructions to provide a first frame of the plurality of video frames showing a user action on an object and a second frame of the plurality of video frames, and wherein the second frame of the plurality of video frames shows a result of the user action.

In some aspects, the techniques described herein relate to a system, wherein the AI includes a neural network trained to receive the video and determine therefrom the user intention.

In some aspects, the techniques described herein relate to a system, wherein the neural network is trained to determine the user intention, including: collecting a set of prior test scripts, each prior test script including a number of tests to test a prior application under test; applying one or more transformations to each of the prior test script, including selecting a different target object to perform at least one of the number of tests, altering the at least one of the number of tests, adding or removing a redundant tests, combining two or more of the number of tests, separating at least one of the number of tests to create a modified set of the number of tests; creating a first training set including the collected set of prior test scripts, the modified set of prior test scripts, and a set of test that fail to reproduce the user intention; training the neural network in a first stage of training using the first training set; creating a second training set for a second stage of training including the first training set and members of the set of prior test scrips absent tests to reproduce the user intention incorrectly detected as having the user intention after the first stage of training; and training the neural network in the second stage of training using the second training set.

In some aspects, the techniques described herein relate to a system, wherein training the neural network further includes training the neural network on the set of test script generated from videos of the set of prior users using the prior application under test within a common domain as the AUT.

In some aspects, the techniques described herein relate to a system, further including executing the test script to test the AUT.

In some aspects, the techniques described herein relate to a test script generating device, including: at least one microprocessor coupled with a computer memory including instructions that, when read by the at least one microprocessor, cause the microprocessor to: access a video including a plurality of video frames of a user using an application under test (AUT); provide at least one of the plurality of video frames to an artificial intelligence (AI) and receive therefrom a user intention associated with the AUT; generate a test script including a set of operations that perform the user intention; and write the test script to a data storage.

In some aspects, the techniques described herein relate to a test script generating device, wherein the instructions to cause the at least one microprocessor to provide the at least one of the plurality of video frames to the AI and receive therefrom the user intention associated with the AUT, further include instructions to cause the at least one microprocessor to execute the AI and provide the at least one of the plurality of video frames to the AI executing thereon.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a block diagram in accordance with embodiments of the present disclosure;

FIG. 3 depicts a process in accordance with embodiments of the present disclosure;

FIG. 4 depicts a process in accordance with embodiments of the present disclosure; and

FIG. 5 depicts a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

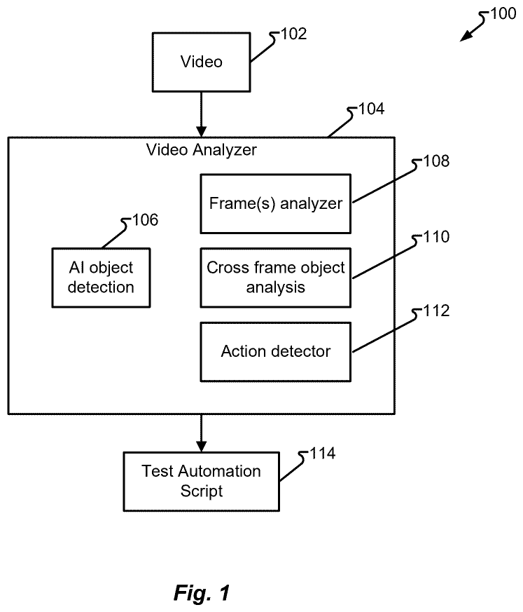

FIG. 1 depicts block diagram 100 in accordance with embodiments of the present disclosure. In one embodiment, video 102 is provided to video analyzer 104 to produce test automation script 114. Video analyzer 104 utilizes AI object detection 106 to determine graphical elements that are presented on a graphical user interface (GUI) by an application under test (AUT). AI object detection 106 may comprise optical character recognition (OCR) and/or more complex analysis abilities (e.g., identify a radio button, scrolling operation, free-form text entry, etc.). Frame analyzer 108 examines actions that occur on a single frame or multiple frames of video 102. Additionally or alternatively, frame analyzer 108, cross frame object analysis 110, and/or AI object detection 106 may initially fail to determine, or determine with insufficient confidence, the identity of an object from a single frame of video 102. Accordingly, a plurality of frames of video 102 may be analyzed to confirm or determine the identity and/or purpose of an object. For example, an object may be a button with text “OK.” By itself, the purpose of such an object may be unknown, or determined with low confidence. However, after the button has been clicked on, as observed by a subsequent frame, the action will be reflective of the purpose of the button and, therefore, identity of the “OK” button may be determined with greater certainty. For clarity, the term “frame” herein refers to a single video image, akin to a single still image of a movie film, and not to the boundary of the image. A frame may be a single scan that captures all the content within the boundary of an image or multiple scans (e.g., interlaced).

Cross frame object analysis 110 determines the difference(s) that occurred in one frame of the video compared to a subsequent frame, such as the frame that immediately follows, to determine differences therebetween. For example, an object of a GUI may change, a different page may load, information not previously displayed may now be displayed or vice versa, etc. Each and every frame of video may be analyzed. However, frames may be omitted if identical or nearly identical (e.g., a mouse pointer jitter) in order to conserve processing and data storage resources. Action detector 112 examines the video for indicators of user actions via an input device (e.g., a mouse, keyboard, etc.) that comprises the difference between the video frames and, therefore, is determined to be the cause of the difference. For example, a button was presented in one frame with a mouse pointer overlaying the button, and new information was presented; therefore, a mouse click was determined to be the action applied to the button. The observation (e.g., analyzing video 102) determines the GUI objects presented on a display and observes/determines the actions that are applied to the GUI objects, which is then utilized to generate a test automation script 114 determined solely from video 102. Video 102 may be captured and analyzed in real-time or recorded and analyzed at a later time.

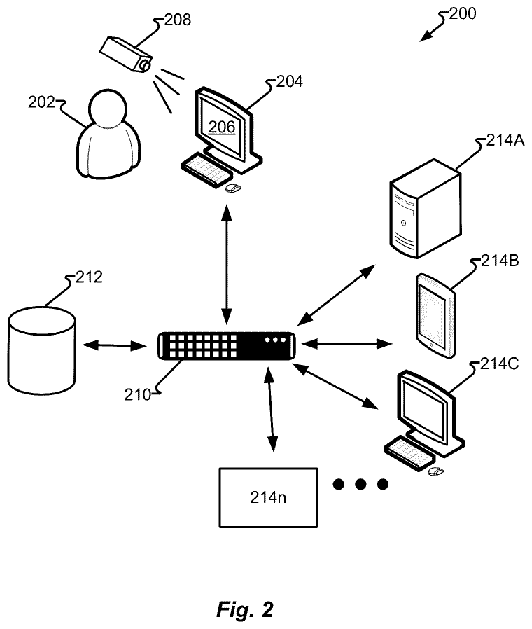

FIG. 2 illustrates system 200 in accordance with embodiments of the present disclosure. In one embodiment, system 200 illustrates components comprising computing components 204, 210, 214A-214n, and 208 and a data storage component (e.g., data storage 212) interconnected, such as via a network. It should be appreciated that, in one embodiment, each of the illustrated components provides a single service. However, one of ordinary skill in the art will recognize that other topologies may be deployed without departing from the scope of embodiments herein. For example, a certain component may be embodied as a plurality of components and/or certain two or more components may be embodied as a single component. In one embodiment, the components as illustrated perform a single function, and in other embodiments, one or more components may perform a plurality of functions and/or one or more functions may be performed by a plurality of components including as a service (e.g., software as a service (SaaS)).

In one embodiment, AUT 206 outputs, at least in part, a GUI comprising one or more graphical objects (or, more simply, “object” or “objects”) on a display associated with computer 204. User 202 interacts with computer 204 and AUT 206 with one or more input-output devices, such as a mouse, trackball, keyboard, etc. The display of computer 204 is used to present graphical elements (e.g., AUT 206) to user 202. A video, such as video 102, may be captured via camera 208 or directly from an output of computer 204 (e.g., a video card output, conferencing application utilizing screen sharing, etc.) and provided to server 210. Alternatively, video 102 may be provided directly to a storage, such as data storage 212, and retrieved by server 210 at a later time.

Computer 204 is variously embodied and may include, but is not limited to, personal computers, portable computers, cellular telephones, etc., or any electronic device comprising a display (e.g., an automatic teller machine, a fuel pump, a smart watch, etc.). In another embodiment, video 102 is captured by camera 208 viewing the display of computer 204 and the output thereof provided to server 210. Server 210 is variously embodied and comprises at least one microprocessor. Server 210 may comprise a plurality of processors (e.g., processing cores, multi-processor cards) and/or a plurality of processing devices, such as a server farm, “cloud,” etc. Server 210 may integrate and/or utilize data storage 212 to maintain data.

Server 210 analyzes the frames of video 102 such as by executing AI object detection 106, frame analyzer 108, cross frame object analysis 110, and/or action detector 112 to produce test automation script 114. Test automation script 114 may be stored, such as in data storage 212, and/or applied to test another application, such as on one or more test platforms 214, such as personal computer 214A, mobile phone 214B, computer executing web client 214C, and other devices executing the other application (e.g., test platform 214n).

In another embodiment, server 210 executes an AI agent to determine an intention of user 202 to perform one or more operations. The user intention is a data value known to a computing component of system 200, such as server 210. The actual intention within the mind of user 202 is not utilized. The AI agent may be provided with a prompt generated by server 210 and/or another device to cause the AI agent to determine the intention. The prompt may comprise one or more frames of video 102, an action determined from action detector 112, and a number of previous video frames and/or actions, such as may be maintained in data storage 212. The prompt then requests the AI to analyze the frames of video 102 to determine an intention.

Determining an intention allows for non-substantive differences in the AI to be accounted for and test automation script 114 remains operational. For example, user 202 may interact with a login feature of AUT 206, which asks for “User Name.” However, an automated test script may fail if a subsequent test of AUT 206 has been changed to request, “Account Holder Name.” To avoid situations where the subsequent version of AUT 206 is untestable due to a change in appearance, or other non-functional differences that may have occurred when AUT 206 was tested and video 102 captured, the AI agent determines the user intention (e.g., the user is interacting with AUT 206 to logon to access private information of AUT 206). The AI agent may comprise, in whole or in part, a neural network trained on a data set of login equivalences, such as from prior videos of AUTs being tested (e.g., one previous user was prompted to “enter email and password,” and in response, the previous user was presented with a welcome screen; another previous user was prompted to enter “Name” and “Passcode” and was presented with private information; etc.). Additionally or alternatively, the AI agent may be trained to determine more complex intentions (e.g., changing a flight, cancelling a hotel reservation, etc.) from a series of actions determined from a number of video frames.

In another embodiment, server 210 executing the AI agent may generate an automated test script for one or more target devices or platforms, such as one or more test platforms 214. The automated test script may be customized for a particular device, for example, mobile phone 214B may be a device that obtains application customization settings from another source, such as the device itself. For example, all login operations for applications executing on mobile phone 214B may result in a pop-up dialog stating “Authentication” and requesting a “User ID,” even though video 102 captured AUT 206 requesting “User Name.” As a result, the AI agent may fine tune the automated test script, which would otherwise anticipate “User Name,” to detect the dialog and/or the request for “User Name” to accommodate the operation of mobile phone 214B. Additionally or alternatively, the AI agent may be trained to identify intentions and various implementations available for such intentions, such as to detect one or more of “User Name,” “User ID,” “Account Holder Name,” etc. and write a test of the automation test script accordingly.

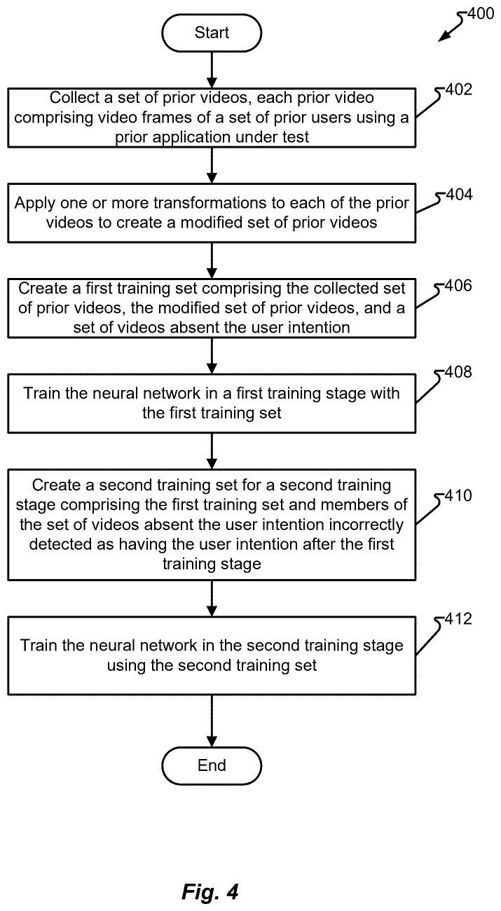

In one embodiment, server 210 executing one or more AI agents may comprise an AI agent executed on a neural network (see FIG. 4). In another embodiment, server 210 executing one or more AI agents executing on an unsupervised AI agent. The unsupervised AI is provided with a prompt, such as a prompt generated by server 210, that comprises the at least one of the plurality of video frames, a domain (e.g., banking, airline reservations, technical support, etc.) associated with the AUT, a plurality of prior videos, each prior video comprising a prior user interacting with a prior application under test to accomplish a prior user intention, and a request to determine the user intention. In another embodiment, server 210 executing one or more AI agents executing on a supervised AI agent. The supervised AI agent is provided with a prompt, similar to a prompt used with an unsupervised AI, agent but further including a subsequent video frame that occurred after a user action on an object and the request to determine the user intention that resulted therefrom.

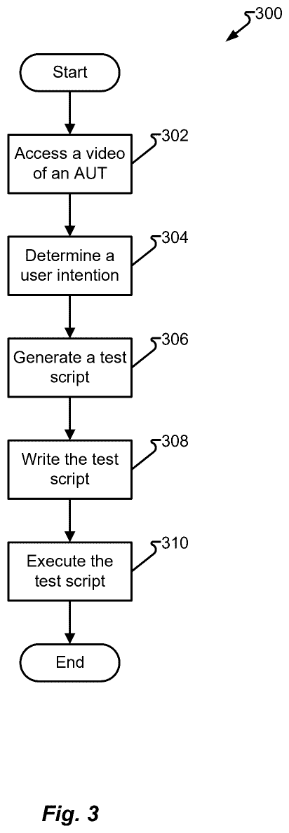

FIG. 3 depicts process 300 in accordance with embodiments of the present disclosure. In one embodiment, process 300 is embodied as machine-readable instructions maintained in a non-transitory memory that when read by a machine, such as one or more microprocessors of a server or servers, cause the machine to execute the instructions and thereby execute process 300. The microprocessor of the server may include, but is not limited to, at least one microprocessor of server 210.

In one embodiment, process 300 begins, and in step 302, a video is accessed, such as video 102. Accessing the video may comprise receiving a live video feed of a real-time interaction with a user and AUT or stored video comprising a previous interaction with a user and AUT. Step 304 determines the user intention. The intention may be for the entirety of the AUT or a portion thereof. The intention does not include the action itself (e.g., clicking on an “OK” button is not a user intention) but rather the meaning as to why the action was taken (e.g., to submit a data entry, to select one of a number of options, to purchase a seat on an airline, etc.).

Next, step 306 generates an automated test script based upon the intentions. As a result, the automated test script may be an exact representation of the observed actions in the video (e.g., click on the “OK” button), intent-based interactions (e.g., “determine an object that will submit the form and provide an input to that object.”), procedural (e.g., “If ‘OK’ is present, select ‘OK,’” “else if ‘Next’ is present, select ‘Next,’” “else if ‘Buy’ is present, select ‘Buy,’” “else if ‘Reserve Now’ is present, select ‘Reserve Now’), or a platform specific interaction. Such interactions may be error based, such as “leftclick.button(OK)” returns “Error: Object Not found,” then the automated script may comprise logic to take another action, such as to click on the “Next” button if there is no “OK” button. A platform specific interaction may fine tune the automated test script, such as to specifically target the AUT executing on a mobile phone or other specific test platform 214.

The automated script is written to a computer memory and/or data storage in step 308 and executed on a subsequent test platform in step 310 to test the AUT thereon.

FIG. 4 depicts process 400 in accordance with embodiments of the present disclosure. In one embodiment, process 400 is embodied as machine-readable instructions maintained in a non-transitory memory that when read by a machine, such as one or more processors of a server or servers, cause the machine to execute the instructions and thereby execute process 400. The processor of the server may include, but is not limited to, at least one processor of server 210.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

The neural network may be trained with a training set of objects for object recognition. For example, a collection of prior videos comprising video frames may be obtained and transformed to create a modified set of prior videos. The transformations may include, but are not limited to, a user selecting a different object to initiate a prior user action (e.g., selecting an “OK” button, selecting a “Next” button, selecting a down arrow on a scrollbar, etc.), altering the prior user action (e.g., booking a flight, booking a hotel, canceling a reservation, etc.), and obtaining a different result (e.g., “success,” “failure,” etc.). A first training set is then created with the collection of prior videos, the modified set of prior videos, and a set of user actions that are not associated with an intention (e.g., scrolling up and down, entering information and selecting “cancel,” mouse jitter, etc.).

Specifically referencing process 400, and in one embodiment, step 402 collects a set of prior videos, each prior video comprising video frames of a set of prior users using a prior application under test. Step 404 applies one or more transformations to each of the prior videos, including selecting a different object to perform a prior user action, altering the prior user action, and obtaining a different prior result, to create a modified set of prior videos. Step 406 creates a first training set comprising the collected set of prior videos, the modified set of prior videos, and a set of videos absent the user intention. Step 408 trains the neural network in a first stage of training using the first training set. Step 410 creates a second training set for a second stage of training comprising the first training set and members of the set of videos absent the user intention incorrectly detected as having the user intention after the first stage of training. And Step 412 trains the neural network in the second stage of training using the second training set.

Once trained, the neural network may be provided with frames of a video of an AUT being tested and may determine therefrom the intention of the user interacting with the AUT. With the intention known, the neural network may further generate an automated test script for subsequent testing of the AUT on the same or a different platform.

Similarly, and in another embodiment, process 400 is performed wherein prior test scripts are used to train the neural network. A set of prior test scripts is collected, each prior test script comprising a number of tests to test a prior application under test. One or more transformations is applied to each of the prior test script, including selecting a different target object to perform at least one of the number of tests, altering the at least one of the number of tests, adding or removing a redundant tests, combining two or more of the number of tests, separating at least one of the number of tests to create a modified set of the number of tests. A first training set is created comprising the collected set of prior test scripts, the modified set of prior test scripts, and a set of test that fail to reproduce the user intention. The neural network is trained in a first stage of training using the first training set. A second training set is created for a second stage of training comprising the first training set and members of the set of prior test scrips absent tests to reproduce the user intention incorrectly detected as having the user intention after the first stage of training. The neural network is trained in the second stage of training using the second training set.

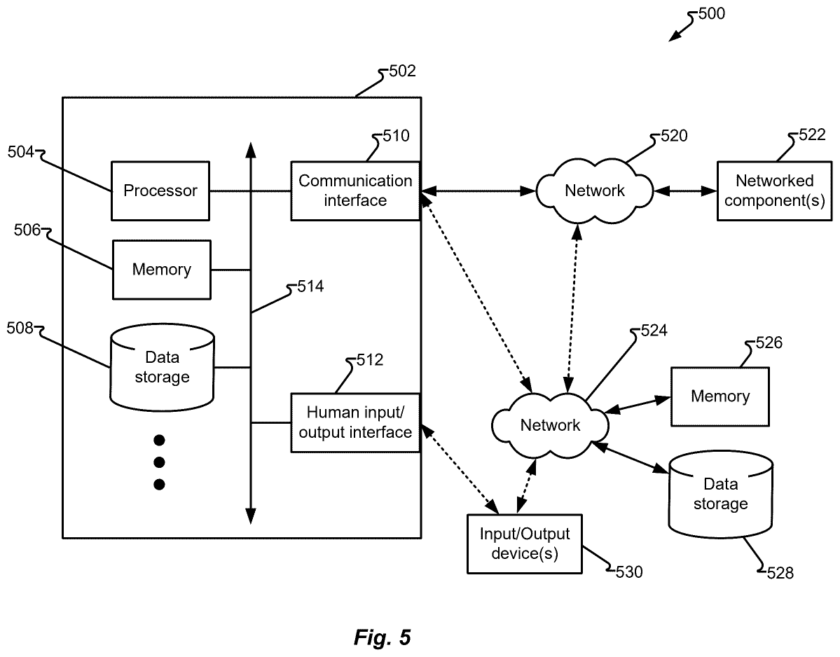

FIG. 5 depicts device 502 in system 500 in accordance with embodiments of the present disclosure. In one embodiment, server 210, computer 204, and/or test platform 214 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud,” “farm,” etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), clouds, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMS, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method, comprising:
accessing a video comprising a plurality of video frames of a user using an application under test (AUT);
using an artificial intelligence (AI) to determine a user intention associated with the AUT from at least one of the plurality of video frames;
generating a test script comprising a set of operations that perform the user intention; and
writing the test script to a data storage.

2. The method of claim 1, wherein using the AI to determine the user intention associated with the AUT from at least one of the plurality of video frames further comprises providing a prompt to the AI, the prompt comprising the at least one of the plurality of video frames, a domain associated with the AUT, a plurality of prior videos, each prior video comprising a prior user interacting with a prior application under test to accomplish a prior user intention, and a request to determine the user intention.

3. The method of claim 1, wherein generating the test script comprising the set of operations that perform the user intention further comprises generating the test script to comprise variations of at least one of a user action and an object of a graphical user interface (GUI) generated by the AUT receiving the user action.

4. The method of claim 1, wherein using the AI to determine the user intention associated with the AUT from at least one of the plurality of video frames further comprises detecting a user action performed on an object of a graphical user interface (GUI) generated by the AUT.

5. The method of claim 1, wherein using the AI to determine the user intention associated with the AUT from at least one of the plurality of video frames further comprises providing a first frame of the plurality of video frames showing a user action on an object and a second frame of the plurality of video frames, and wherein the second frame of the plurality of video frames shows a result of the user action.

6. The method of claim 1, wherein the AI comprises a neural network trained to receive the video and determine therefrom the user intention.

7. The method of claim 6, wherein the neural network is trained to determine the user intention, comprising:
collecting a set of prior videos, each prior video comprising video frames of a set of prior users using a prior application under test;
applying one or more transformations to each of the prior videos, including selecting a different object to perform a prior user action, altering the prior user action, and obtaining a different prior result to create a modified set of prior videos;
creating a first training set comprising the collected set of prior videos, the modified set of prior videos, and a set of videos absent the user intention;
training the neural network in a first stage of training using the first training set;
creating a second training set for a second stage of training comprising the first training set and members of the set of videos absent the user intention incorrectly detected as having the user intention after the first stage of training; and
training the neural network in the second stage of training using the second training set.

8. The method of claim 7, wherein training the neural network further comprises training the neural network on the set of prior videos comprising videos of the set of prior users using the prior application under test within a common domain as the AUT.

9. The method of claim 1, further comprising executing, test script to test the AUT.

10. A system, comprising:
at least one microprocessor coupled with a computer memory comprising instructions that, when read by the at least one microprocessor, cause the microprocessor to:
access a video comprising a plurality of video frames of a user using an application under test (AUT);
execute an artificial intelligence (AI) to determine a user intention associated with the AUT from at least one of the plurality of video frames;
generate a test script comprising a set of operations that perform the user intention; and
write the test script to a data storage.

11. The system of claim 10, wherein executing the AI to determine the user intention associated with the AUT from at least one of the plurality of video frames further comprises instructions to provide a prompt to the AI, the prompt comprising the at least one of the plurality of video frames, a domain associated with the AUT, a plurality of prior videos, each prior video comprising a prior user interacting with a prior application under test to accomplish a prior user intention, and a request to determine the user intention.

12. The system of claim 10, wherein the instructions to generate the test script comprising the set of operations that perform the user intention further comprise instructions to generate the test script to comprise variations of at least one of a user action and an object of a graphical user interface (GUI) generated by the AUT receiving the user action.

13. The system of claim 10, wherein executing the AI to determine the user intention associated with the AUT from at least one of the plurality of video frames further comprises instructions to detect a user action performed on an object of a graphical user interface (GUI) generated by the AUT.

14. The system of claim 10, wherein executing the AI to determine the user intention associated with the AUT from at least one of the plurality of video frames further comprises instructions to provide a first frame of the plurality of video frames showing a user action on an object and a second frame of the plurality of video frames, and wherein the second frame of the plurality of video frames shows a result of the user action.

15. The system of claim 10, wherein the AI comprises a neural network trained to receive the video and determine therefrom the user intention.

16. The system of claim 15, wherein the neural network is trained to determine the user intention, comprising:
collecting a set of prior test scripts, each prior test script comprising a number of tests to test a prior application under test;
applying one or more transformations to each of the prior test script, including selecting a different target object to perform at least one of the number of tests, altering the at least one of the number of tests, adding or removing a redundant tests, combining two or more of the number of tests, separating at least one of the number of tests to create a modified set of the number of tests;
creating a first training set comprising the collected set of prior test scripts, the modified set of prior test scripts, and a set of test that fail to reproduce the user intention;
training the neural network in a first stage of training using the first training set;
creating a second training set for a second stage of training comprising the first training set and members of the set of prior test scrips absent tests to reproduce the user intention incorrectly detected as having the user intention after the first stage of training; and
training the neural network in the second stage of training using the second training set.

17. The system of claim 16, wherein training the neural network further comprises training the neural network on the set of test script generated from videos of the set of prior users using the prior application under test within a common domain as the AUT.

18. The system of claim 10, further comprising executing the test script to test the AUT.

19. A test script generating device, comprising:
at least one microprocessor coupled with a computer memory comprising instructions that, when read by the at least one microprocessor, cause the microprocessor to:
access a video comprising a plurality of video frames of a user using an application under test (AUT);
provide at least one of the plurality of video frames to an artificial intelligence (AI) and receive therefrom a user intention associated with the AUT;
generate a test script comprising a set of operations that perform the user intention; and
write the test script to a data storage.

20. The test script generating device of claim 19, wherein the instructions to cause the at least one microprocessor to provide the at least one of the plurality of video frames to the AI and receive therefrom the user intention associated with the AUT, further comprise instructions to cause the at least one microprocessor to execute the AI and provide the at least one of the plurality of video frames to the AI executing thereon.
